(19) United States
(12) Patent Application Publication
(10) Pub. No.: US 2013/0283175 A1
(43) Pub. Date: Oct. 24, 2013

(54) SYNCHRONIZATION MANAGEMENT GROUPS

(71) Applicants: Lida Faridian, Ottawa (CA); Michael Jhu, Ottawa (CA); Neelam Khatri, Ottawa (CA); Greg Soprovich, Ottawa (CA)

(72) Inventors: Lida Faridian, Ottawa (CA); Michael Jhu, Ottawa (CA); Neelam Khatri, Ottawa (CA); Greg Soprovich, Ottawa (CA)

(73) Assignee: Alcatel-Lucent Canada Inc., Ottawa (CA)

(21) Appl. No.: 13/453,143

(22) Filed: Apr. 23, 2012

(51) Int. Cl. G06F 3/01; G06F 15/16

(52) U.S. Cl. 715/736

(57) ABSTRACT

Various exemplary embodiments relate to a method and related network node including one or more of the following: displaying, by the network management system, a first representation of a synchronization topology, wherein the synchronization topology includes a set of network elements and a set of peers; receiving a selection of at least one selected network element of the set of network elements; identifying at least one identified peer of the set of peers associated with the at least one selected network element; adding the at least one identified peer of the set of peers to a first synchronization group; and displaying a second representation of the synchronization topology, wherein the second representation includes a representation of the first synchronization group.

### CROSS-REFERENCE TO RELATED APPLICATIONS

This application is related to the following co-pending application which is incorporated by reference herein: application Ser. No. ______, Attorney Docket Number ALC 3801, “Synchronization Topology and Route Analytics Integration.”

### TECHNICAL FIELD

Various exemplary embodiments disclosed herein relate generally to network management

### BACKGROUND

In many systems, it is desirable or sometimes necessary to synchronize time or frequency among multiple devices on a computer network. To provide such synchronization functionality, various protocols have been proposed to distribute accurate timing information among devices in a system. For example, the Precision Time Protocol (PTP), defined in the IEEE 1588 standard, describes a master-slave or peer-peer architecture wherein timing information provided by a grandmaster clock (such as an atomic clock) is distributed in a hierarchical manner through various master and slave nodes. Given the dynamic nature of various computer networks that may underlie the devices participating in such a synchronization scheme, it is likely that changes to router and link availability may impact the performance of this synchronization. As such, it may be desirable to provide a method of monitoring and managing various devices cooperating with each other to achieve time or frequency synchronization.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a network management system for displaying a synchronization topology, the method including: displaying, by the network management system, a first representation of a synchronization topology, wherein the synchronization topology includes a set of network elements and a set of peers; receiving a selection of at least one selected network element of the set of network elements; identifying at least one identified peer of the set of peers associated with the at least one selected network element; adding the at least one identified peer of the set of peers to a first synchronization group; and displaying a second representation of the synchronization topology, wherein the second representation includes a representation of the first synchronization group.

Various exemplary embodiments relate to a network management system for displaying a synchronization (sync) topology, the network management system including: a user interface; a sync peer storage configured to store information related to peers; a sync group storage configured to store information related to groupings of peers; a sync group creator configured to receive, via the user interface, a selection associated with at least two peers for which the sync peer storage stores information, and update the sync group storage to include information related to a grouping of the at least two peers; and a sync topology generator configured to: generate a first representation of the sync topology, wherein the first representation represents the grouping of the at least two peers as a unit, and display the first representation via the user interface.

Various exemplary embodiments relate to a non-transitory machine-readable storage medium encoded with instructions for execution by a network management system for displaying a synchronization topology, the medium including: instructions for displaying, by the network management system, a first representation of a synchronization topology, wherein the synchronization topology includes a set of network elements and a set of peers; instructions for receiving a selection of at least one selected network element of the set of network elements; instructions for identifying at least one identified peer of the set of peers associated with the at least one selected network element; instructions for adding the at least one identified peer of the set of peers to a first synchronization group; and instructions for displaying a second representation of the synchronization topology, wherein the second representation includes a representation of the first synchronization group.

Various embodiments are described wherein the first synchronization group further includes the at least one selected network element.

Various embodiments are described wherein the second representation includes a representation of a number of peers less than the number of peers belonging to the set of peers.

Various embodiments additionally include receiving a selection of the first synchronization group; and displaying a third representation of the first synchronization group, wherein the third representation includes a representation of at least one peer belonging to the synchronization group.

Various embodiments are described wherein the third representation of the first synchronization group includes a representation of a second synchronization group.

Various embodiments additionally include: discovering a new peer wherein the new peer is associated with the at least one selected network element; and adding the new peer to the first synchronization group.

Various embodiments are described wherein, the synchronization topology is associated with a synchronization domain, and the step of identifying at least one identified peer of the set of peers includes ensuring that the at least one identified peer belongs to the synchronization domain.

Various embodiments are described wherein the second representation includes at least one of a map and a list.

Various exemplary embodiments relate to a method performed by a network management system for displaying a synchronization topology, the method including: displaying, by the network management system, a first representation of a synchronization topology, wherein the synchronization topology includes a set of network elements and a set of peers; identifying a set of peers to be monitored; receiving an indication that a network path associated with a peer of the set of peers to be monitored has changed; and displaying an alarm indication. The network path may be a routed (e.g. hop-by-hop) network path or hierarchical (service-to-routed) network path.

Various exemplary embodiments relate to a network management system for displaying a synchronization topology, the network management system including: a user interface; a network interface; a synchronization peer storage configured to store information related to a set of peers; an alarm storage configured to store information related to alarms; a synchronization topology generator configured to display, via the user interface, a first representation of a synchronization topology; an alarm creator configured to store information related to an alarm in the alarm storage; a route analyzer configured to receive, via the network interface, an indication of a change to a network topology; and an alarm evaluator configured to: determine that the change to the network topology triggers the alarm, and display, via the user interface, an indication that the alarm has been triggered.

Various exemplary embodiments relate to a non-transitory machine-readable storage medium encoded with instructions for execution by a network management system for displaying a synchronization topology, the medium including: instructions for displaying, by the network management system, a first representation of a synchronization topology, wherein the synchronization topology includes a set of network elements and a set of peers; instructions for identifying a set of peers to be monitored; instructions for receiving an indication that a network path associated with a peer of the set of peers to be monitored has changed; instructions for displaying an alarm indication.

Various embodiments are described wherein, the peer is associated with a synchronization group, the first representation of a synchronization topology includes a representation of the synchronization group, and the step of displaying an indication that the alarm has been triggered including displaying the indication in association with the synchronization group.

Various embodiments are described wherein the step of identifying a set of peers to be monitored includes receiving a definition of an alarm, wherein the definition includes trigger criteria, the method further including determining whether the indication that a network path associated with the peer has changed meets the trigger criteria.

Various embodiments additionally include receiving a selection of the peer; displaying a second representation of a network topology, wherein the second representation includes a representation of a current network path associated with the peer.

Various embodiments additionally include receiving a request for a historical analysis view; and displaying a third representation of the network topology, wherein the third representation includes a representation of a network path associated with the peer at a previous time.

Various embodiments are described wherein the step of receiving a configuration of an alarm for a peer of the set of peers including: receiving a selection of a synchronization group; displaying a second representation of the synchronization topology, wherein the second representation includes a representation of the peer; receiving a selection of the peer; and receiving an indication that an alarm should be set for the peer.

### BRIEF DESCRIPTION OF THE DRAWINGS

In order to better understand various exemplary embodiments, reference is made to the accompanying drawings, wherein:

FIG. 1 illustrates an exemplary graphical user interface (GUI) representing an exemplary synchronization domain;

FIG. 2 illustrates an exemplary GUI representing an exemplary synchronization domain including a synchronization group;

FIG. 3 illustrates an exemplary GUI representing an exemplary synchronization group;

FIG. 4 illustrates an exemplary network management system for managing synchronization domains;

FIG. 5 illustrates an exemplary method for establishing a synchronization group;

FIG. 6 illustrates an exemplary network topology underlying a portion of a synchronization domain;

FIG. 7 illustrates an exemplary network topology underlying a portion of a synchronization domain and including network failures;

FIG. 8 illustrates an exemplary GUI representing an exemplary synchronization domain including a synchronization group and an alarm indication;

FIG. 9 illustrates an exemplary GUI representing an exemplary synchronization group and an alarm indication; and

FIG. 10 illustrates an exemplary method for configuring and evaluating an alarm.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Further, as used herein, the term “sync” will be understood to be synonymous with the term “synchronization.”

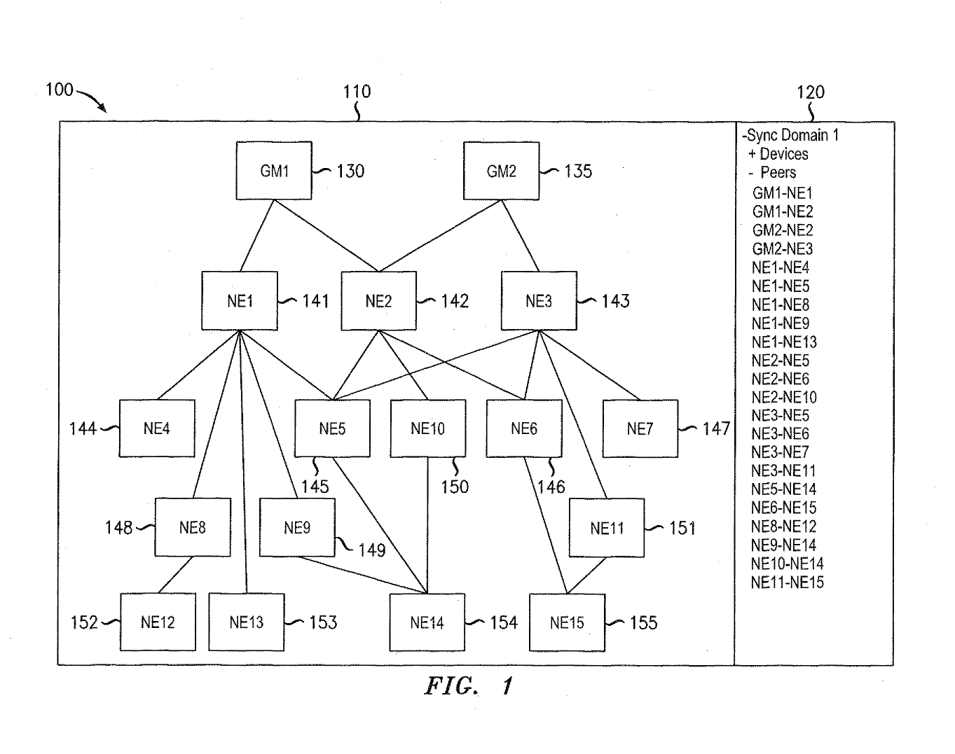

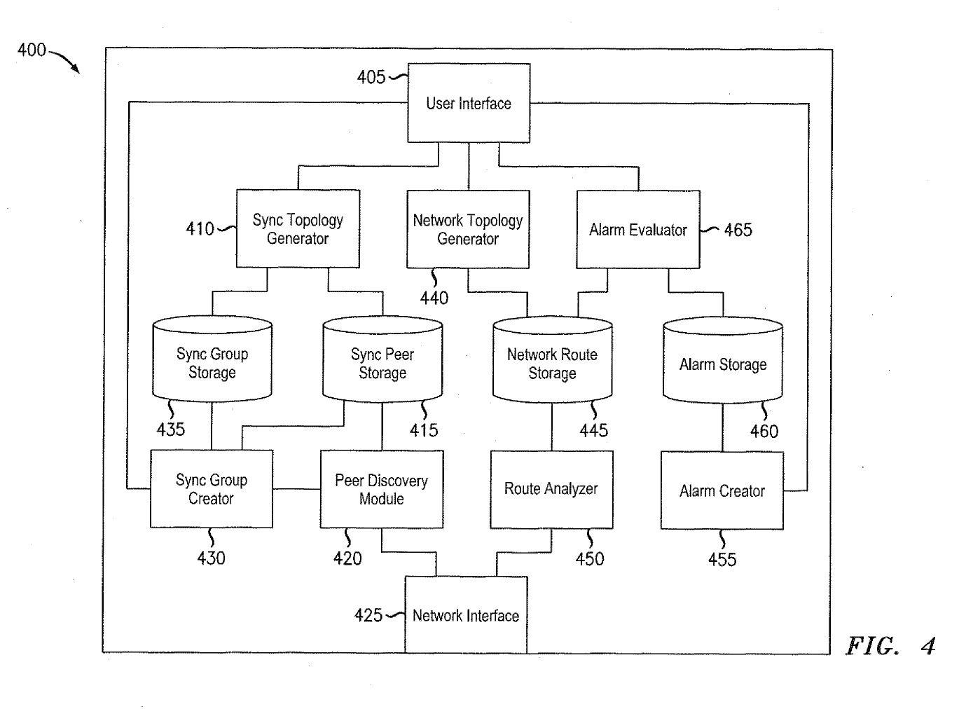

FIG. 1 illustrates an exemplary graphical user interface (GUI) 100 representing an exemplary synchronization domain. GUI 100 may be generated and displayed by a network management system (NMS) such as the exemplary NMS described in greater detail below with respect to FIG. 4. GUI 100 may include one or more representations 110, 120 of a sync topology. Such representations may take any form such as a map 110 or a list 120. As illustrated, map 110 and list 120 may illustrate a single sync domain or may illustrate multiple sync domains (not shown). As will be understood, the illustrated sync domain or sync topology may represent, for example, a PTP synchronization domain. As such, the sync topology may indicate a relationship of peers, masters, and slaves to provide paths that clock synchronization signals may travel through the various devices participating in the sync domain. For example, a clock synchronization signal may originate at a grandmaster clock and be sent to one or more master devices. These master devices may, in turn, propagate the clock synchronization signal to one or more slave devices or additional master devices. It will also be understood that various intermediate devices may exist between the network devices participating in a synchronization domain. For example, a grandmaster clock may be connected to a master device through one or more network routers that do not participate in the sync domain. In such embodiments, a peer relationship between two devices in a sync topology may be tied to an IP path traversing multiple intermediate routers in a routing topology.

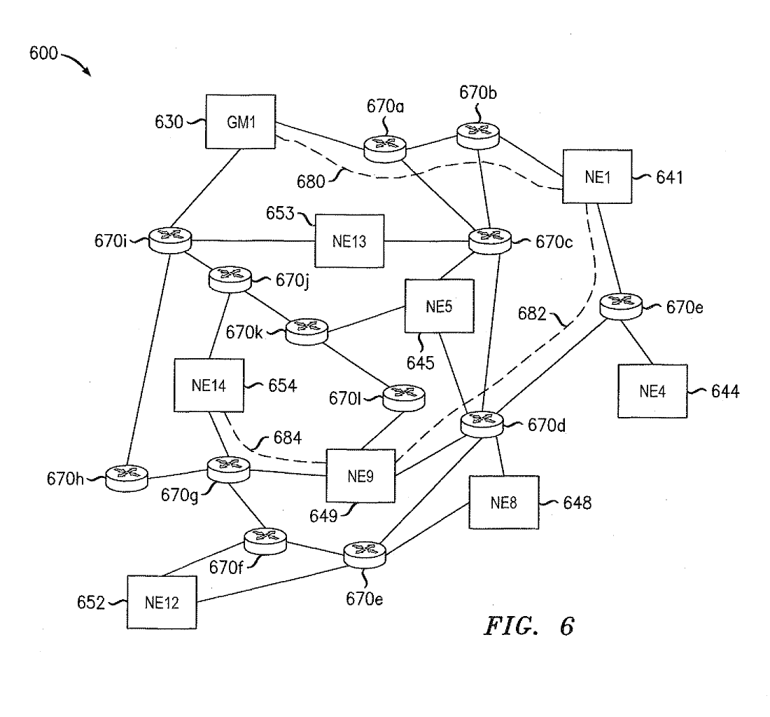

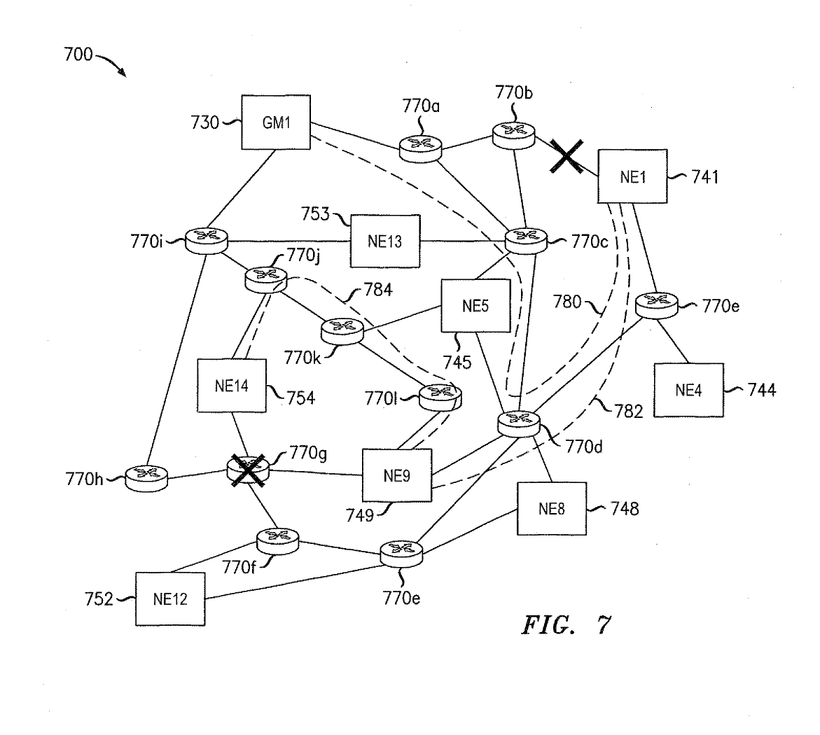

Exemplary map 110 may include two grandmaster clocks 130, 135 and fifteen additional network elements 141-155. In various embodiments, one or more grandmaster clocks may not be discovered by the NMS, in which case such grandmaster clocks may not be displayed by map 110 or GUI 100. In such embodiments, the managed advertising router for the unmanaged grandmaster clock may be the “highest” device on the map. Various elements within map may be coupled to each other in a peer relationship. For example, a peer may exist between GM1 130 and NE1 141. As another example, another peer may exist between NE1 141 and NE13 153. On map 110, each such peer may be represented as a line connecting two network elements. In various embodiments, the existence of a peer may indicate that one of the network elements is configured to provide synchronization signals to the device on the other end of the peer. As noted above, the GMs 130, 135, and NEs 141-155 may not be directly connected to each other and, instead, may be connected via intermediate devices. As such, at any given time, a peer may represent or otherwise be associated with one or more specific paths through these intermediate nodes. An exemplary underlying routing topology will be discussed in greater detail below with respect to FIGS. 6 and 7.

Exemplary list 120 may also represent the sync domain that map 110 represents. In various embodiments, list 120 may be a hierarchical and collapsible list. Thus, while list 120 may include each of the devices 130, 135, 141-155, the devices may be hidden under a collapsed branch labeled “Devices.” List 120 may also include each of the peers that are members of the sync domain. For example, list 120 may include the peer between GM1 130 and NE1 141. As another example, list 120 may include the peer between NE1 141 and NE13 153.

In various embodiments, the number of devices and peers belonging to a sync domain may be very large. For example, a sync domain may include thousands of peers. As such, it may be difficult to present an entire sync domain in a single view of a sync topology that is organized and easy for a user to interpret. As such, an NMS presenting GUI 100 may enable a user to group peers or network devices into one or more synchronization groups. For example, a user may send an instruction to create a new sync group and select NE1 141, NE4 144, NE8 148, NE9 149, NE12 152, NE13 153. The NMS may then group any peers belonging to the sync domain and having at least one endpoint on one of the selected devices.

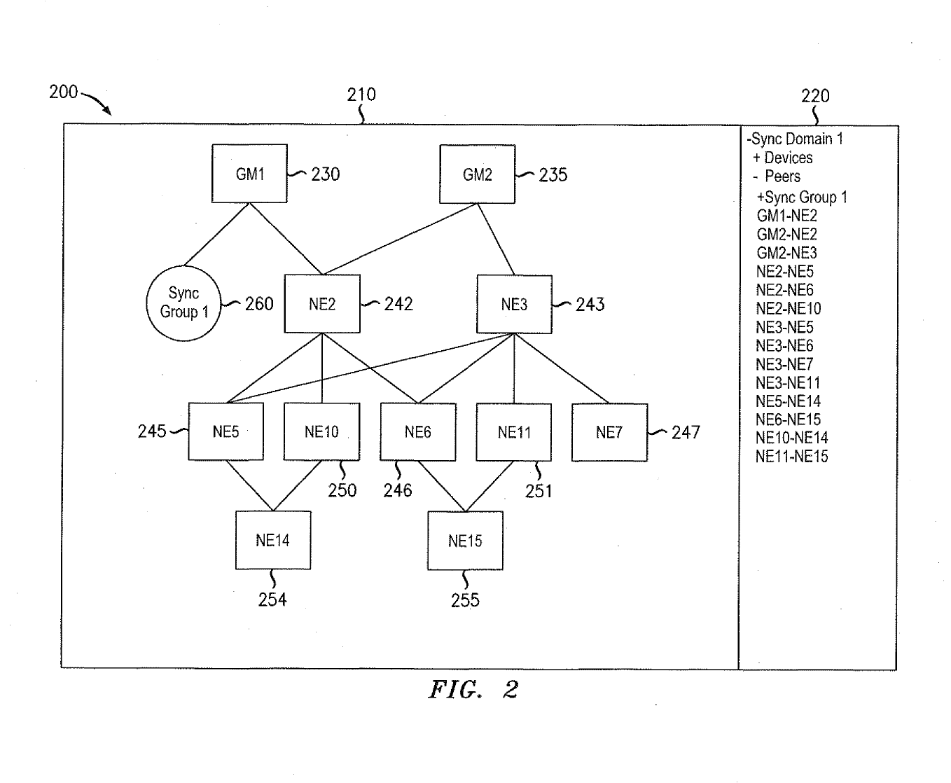

FIG. 2 illustrates an exemplary GUI 200 representing an exemplary synchronization domain including a synchronization group. As illustrated, GUI 200 may include a map 210 and a list 220 representing the sync domain. GUI 200 may represent the sync domain represented by GUI 100 after the creation of a sync group. As such, map 210 may include two grandmaster clocks 230, 235, a number of network elements 242, 243, 245-247, 250, 251, 254, 255, and a number of peers similar to those included in map 110 of GUI 100.

Map 210 may also include a representation of a sync group, Sync Group 1 260. Sync Group 1 260 may represent, as a unit, any peers originating from at least one of NE1 141, NE4 144, NE8 148, NE9 149, NE12 152, NE13 153 of GUI 100. As illustrated, any NE far which all associated peers are included in Sync Group 1 260 may not be displayed in map 210. Conversely, any NE that includes at least one peer not included in Sync Group 1 260 may be represented separately in map 210. For example, the only peer originating at NE13 153 in GUI 100 is included in Sync Group 1 and NE13 is therefore omitted from GUI 110. As another example, while the peer between NE1 141 and NE5 145 is included in Sync Group 1 260, the peer between NE2 242 and NE5 245 is not included in Sync Group 1 260. As such, NE5 245 is included in map 210. In this manner, map 210 may display fewer devices, peers, and other constructs, thereby facilitating an organized representation of a sync domain.

As will be understood, various alternative criteria may be employed for determining which devices to illustrate on a GUI including a sync group. For example, a GUI may omit only those network elements selected as part of a Sync Group. In such embodiments, even if the only peers associated with an unselected device are included in a Sync Group, a GUI may still represent the unselected device on the map.

As further illustrated, Sync Group 260 may be shown as having only one “peer” from GM1 230. As shown, a map may include a representation of a “peer” to show from where a clock signal originates for the Sync Group. The represented peer may not correspond to an actual peer because Sync Group 1 260 may not represent any single device. Further, map 210 may not represent any other peers exiting the Sync Group 1 260. For example, while Sync Group 1 may include the peer between NE1 141 and NE5 145, map 210 may not represent any “peer” between Sync Group 1 260 and NE5 245. It will be understood that in various alternative embodiments, map 210 may represent greater or fewer “peers” for example, Sync Group 1 260 may not be displayed with any “peers” or may be displayed with “peers” to any devices still displayed on map 210. For example, map 210 may illustrate a peer between Sync Group 1 260 and both of NE5 245 and NE14 254.

List 220 may also represent the sync domain including the Sync Group 1. As illustrated, the peers grouped into the Sync Group may be removed from the top level peer listing. The top level peer listing may also list an item for Sync Group 1. In various embodiments, the Sync Group 1 item may be expandable to display the constituent peers.

In various embodiments, GUI 200 may enable a user to “drill down” into various Sync Groups such as Sync Group 1 260. For example, by selecting Sync Group 1 260 on map 210 or by selecting the Sync Group 1 item on list 220, the user may instruct GUI 200 to provide a representation of the sync group.

In various embodiments, GUI 200 may enable a user to manage the peers or devices belonging to a Sync Group together. For example, GUI 200 may receive a selection of a Sync Group and a new value for an attribute of the peers or devices. The associated NMS may then apply the new attribute value to at least one of the peers or devices that belong to the Sync Group. For example, the NMS may apply the new attribute value to all peers or devices belonging to the group or to those peers or devices belonging to the group that include the attribute to be modified.

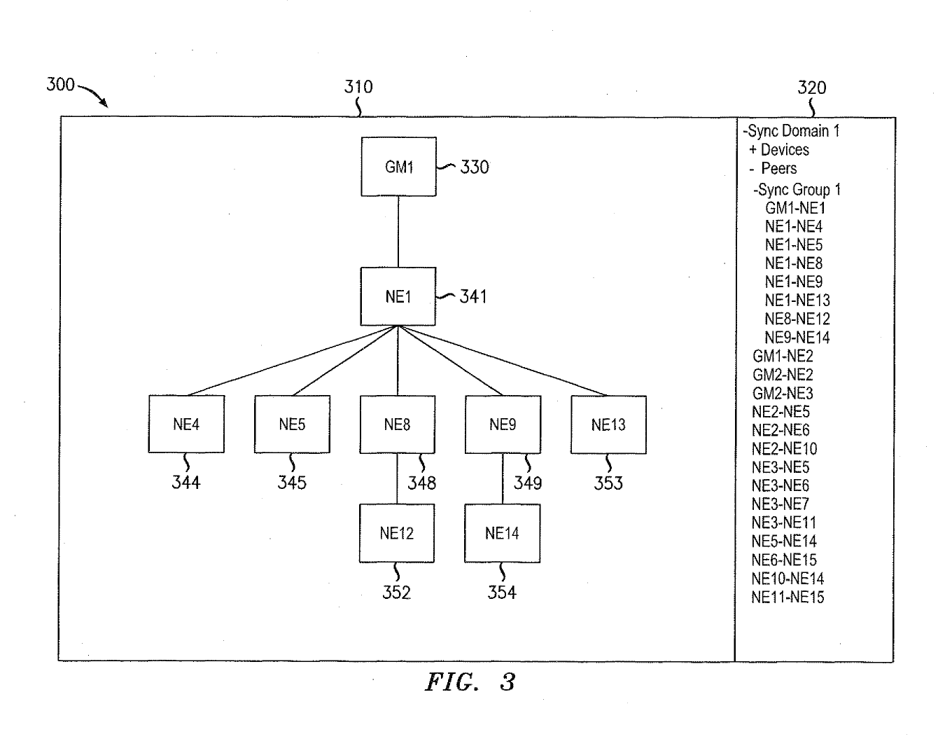

FIG. 3 illustrates an exemplary GUI 300 representing an exemplary synchronization group. As explained with respect to FIG. 2, such a representation of a sync group may be requested by a user by selecting a sync group in a map or list of a higher-level representation of a sync domain.

As shown, map 310 may represent only those peers included in the Sync Group through user selection or automatic group creation based on network topology. Further, map 310 may represent any device from which an included peer originates. As such, map 310 may represent GM1 330, and various NEs 341, 344, 345, 348, 352-354. In various alternative embodiments wherein Sync Groups are created by a user selection of devices, map 310 may only represent those devices actually selected by a user in establishing the represented Sync Group. For example, in such embodiments, map 310 may not include any representation of GM1 330 or NE14 354 because those devices may not have been selected in establishing Sync Group 1. In various embodiments, such unselected devices may be represented as an “external reference.” For example, instead of a box, GM1 330 may be represented by an arrow pointing upward or some other contrasting shape. As another example, NE14 354 may be represented by an arrow pointing downward or some other contrasting shape.

List 320 may also include a detailed representation of Sync Group 1. As shown, the Sync Group 1 item may be expanded to list the eight peers included in that sync group. In various embodiments, list 320 may also display peers located in the top level of the peer list as screen space permits.

In various embodiments, the network management system may enable the definition of Sync Groups within other Sync Groups. For example, in a manner similar to that previously described, a user may be able to select one or more network devices on GUI 300 to be included in a second Sync Group such as NE8 348 and NE12 352. Thereafter, map 310 and list 320 may be updated to include a representation of Sync Group 2 (not shown) in place of the selected devices and peers originating therefrom.

FIG. 4 illustrates an exemplary network management system (NMS) 400 for managing synchronization domains. In various embodiments, NMS 400 may be an Alcatel-Lucent 5620 Service Aware Manager (SAM). NMS 400 may include a number of components such as user interface 405, sync topology generator 410, sync peer storage 415, peer discovery module 420, network interface 425, sync group creator 430, sync group storage 435, network topology generator 440, network route storage 445, route analyzer 450, alarm creator 455, alarm storage 460, and alarm evaluator 465.

User interface 405 may include hardware or executable instructions on a machine-readable storage medium configured to enable user interaction with NMS 400. For example, user interface 405 may include one or more of a monitor, a keyboard, and a mouse. In various embodiments, users may access NMS from a remote device such as a different computer system. In such embodiments, user interface 405 may include a network interface (such as network interface 425) and appropriate software for communicating with such other computer system.

Sync topology generator 410 may include hardware or executable instructions on a machine-readable storage medium configured to generate a representation of a sync topology. For example, sync topology generator 410 may generate a GUI such as GUIs 100, 200, 300 and display such GUIs to a user via user interface 405. Sync topology generator may generate representations of sync topologies based on the contents of sync peer storage 415 or sync group storage 435. Sync topology generator 410 may also receive various commands via user interface 405 and react accordingly. For example, sync topology generator 410 may receive via user interface 405 a selection of a sync group and, in response, provide a detailed representation of the selected sync group such as, for example, map 310 or list 320 of GUI 300.

Sync peer storage 415 may be a device that stores a listing of various peers belonging to various sync domains. Such listing may further identify from which network devices each peer originates. Thus, sync peer storage 415 may include a machine-readable storage medium such as read-only memory (ROM), random-access memory (RAM), magnetic disk storage media, optical storage media, flash-memory devices, and/or similar storage media.

Peer discovery module 420 may include hardware or executable instructions on a machine-readable storage medium configured to maintain up-to-date peer information in sync peer storage 415. As such, peer discovery module 420 may periodically poll, via network interface 425, various network devices to determine what peers originate from those devices. For example, peer discovery module 420 may send simple network management protocol (SNMP) messages to the various devices requesting configured peer information. Alternatively or additionally, such devices may push unsolicited discovery messages for newly-established peers. Upon discovering a new peer, peer discovery module 420 may update the contents of sync peer storage 415. Likewise, upon discovering that a peer has been removed, peer discovery module 420 may update the contents of sync peer storage 415. In various embodiments, peer discovery module 420 may additionally or alternatively discover peers based on routing, In such embodiments, peer discovery 420 module may have access to network topology information (such as through network route storage 445 or route analyzer 450, as will be described in greater detail below) and use this information to identify peer relationships. For example, peer discovery module may determine that a prefix “10.0.0.1/30” may be advertised for a grandmaster clock by router A and router B (not shown). From this information. Peer discovery module 420 may determine that a peer exists between the grandmaster clock and each of router A and router B. Additionally, peer discovery module 420 may discover the routers sourcing the grandmaster clock and subsequently manage them.

Network interface 425 may be an interface including hardware and/or executable instructions encoded on a machine-readable storage medium configured to communicate with at least one other network device. Network interface 425 may include one or more physical ports and may communicate according to one or more protocols such as TCP, IP, or Ethernet.

Sync group creator 430 may include hardware or executable instructions on a machine-readable storage medium configured to establish sync groups based on user input. In various embodiments, sync group creator 430 may receive a selection of one or more network devices via user interface 405, access sync peer storage 415 to identify any peers associated with the selected network devices, and add a new sync group including the identified peers to sync group storage 435. Sync group creator 430 may further automatically update any impacted sync groups upon receiving an indication from peer discovery module 420 that a peer has been added or removed. In various alternative embodiments, sync group creator 430 may simply store an indication of the network devices selected for a sync group in sync group storage 435 to enable sync topology generator 410 to correlate the selected network devices from sync group storage 435 to associated peers stored in sync peer storage 415.

Sync group storage 435 may be a device that stores definitions of various sync groups. For example, sync group storage 435 may store a list of selected network devices or included peers for a number of sync groups. Thus, sync group storage 435 may include a machine-readable storage medium such as read-only memory (ROM), random-access memory (RAM), magnetic disk storage media, optical storage media, flash-memory devices, and/or similar storage media. In various embodiments, sync group storage 435 may include at least some hardware in common with sync peer storage 415. For example, sync group storage 435 and sync peer storage 415 may be separate data structures of a single storage device. The remaining components of exemplary NMS 400 will be described below.

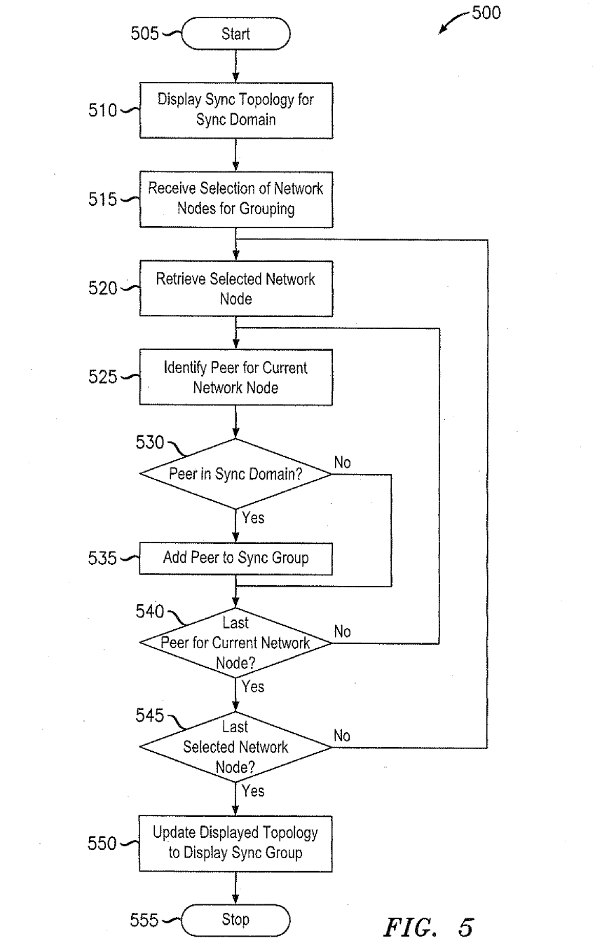

FIG. 5 illustrates an exemplary method 500 for establishing a synchronization group. Method 500 may be performed by an NMS such as, for example, NMS 400. For example, method 500 may be performed by sync topology generator 410 or sync group generator 430.

Method 500 may begin in step 505 and proceed to step 510 where the NMS may display a sync topology for a sync domain. For example, the NMS may display GUI 100. Next, in step 515, the NMS may receive a selection of network nodes to be used in creating a new sync group. Such selection may be received from a user or may be generated automatically by the NMS based on the underlying network topology. The NMS may then begin to iterate through the selected network nodes in step 520 by retrieving a network node to process. Then, with respect to the retrieved network node, the NMS may begin to iterate through the peers originating from that network node by identifying a peer to process in step 525.

In step 530, the NMS may determine whether the current peer belongs to the current sync domain. If the peer belongs to a sync domain other than the currently displayed or active sync domain, the method may proceed to step 540. Otherwise, if the current peer belongs to the current sync domain, method 500 may proceed to step 535. In step 535, the NMS may add the current peer to the sync group currently under construction. Then in step 540, the NMS may determine whether additional peers remain to be processed with respect to the current network node. If additional peers remain, method 500 may loop back to step 525. If the current peer is the last peer to be processed for the network node, method 500 may proceed to step 545.

In step 545, the NMS may determine whether additional selected network devices remain to be processed. If additional selected network nodes remain, method 500 may loop back to step 520. Otherwise, if the current selected network node is the last network node method 500 may proceed to step 550. The NMS may then, in step 550, update the displayed topology. For example, the NMS may generate a new GUI such as GUI 200 to show the sync topology including the newly-created Sync Group.

FIG. 6 illustrates an exemplary network topology 600 underlying a portion of a synchronization domain. As will be understood, the network devices included in a sync domain may not all be directly attached to one another. In various embodiments, devices that are adjacent in a sync topology may be connected via one or more intermediate devices in a network topology. Network topology 600 may include various network devices included in a sync topology such as GM1 630 and network devices 641, 644, 645, 648, 649, 652-654. Network topology 600 may also include various intermediate devices 670a-k that are not part of a sync topology. For example, each of devices 670a-k may be a switch, router, or other network device for enabling communication between other devices.

In various embodiments, a NMS may be capable of storing and displaying to a user a network topology such as exemplary network topology 600. Exemplary network topology 600 may be displayed, for example, upon the user's selection of a peer in a sync topology. The NMS may receive such a peer selection and display at least a portion of the network topology associated with the selected peer. The NMS may also display the routes traffic is currently taking between various devices. Such routes may be correlated to peers belonging to the sync domain. In various such embodiments, the routes correlated to peers may be the routes currently taken by time synchronization signals passed between the two peered devices. For example, route 680 may represent the route taken by synchronization signals sent according to the peer existing between GM1 630 and NE1 641. Likewise, route 682 may represent the route of the peer between NE1 641 and NE9 649, while route 684 may represent the route of the peer between NE9 and NE14. In various embodiments, the NMS may map sync peers to routed paths (hop-by-hop) or hierarchical paths (service-to-routed). For example, according to the hierarchical path mapping, the NMS may map a sync peer to a transport service, such as a multiprotocol label switching (MPLS) virtual private routed network (VPRN), and then map the transport service to a hop-by-hop routed path.

FIG. 7 illustrates an exemplary network topology 700 underlying a portion of a synchronization domain and including network failures. As will be understood, various network-impacting events may alter the route a signal takes between devices. For example, routers or links between routers may fail.

As is illustrated in exemplary network topology 700, a link between device 770b and NE1 741 may fail. As a consequence, the peer between GM1 730 and NE1 741 may be rerouted to follow route 780. While this rerouting may preserve connectivity for the peer, the rerouting may also add two additional “hops” between GM1 730 and NE1 741. In various embodiments, this action may introduce an unacceptable amount of network propagation delay or other undesirable effects for the peer.

As another example, device 770g may fail and be unable to forward any packets. As such, the peer between NE9 749 and NE14 754 may be rerouted according to route 784. Again, this new route adds two additional hops for the sync peer, which may be undesirable. Route 782, on the other hand, may be unaffected by the illustrated failures and may remain unchanged.

In various embodiments, an NMS may allow a user to establish alarms for various peers in a network topology. For example, the user may set an alarm to trigger whenever the route associated with a peer changes or whenever the route exceeds an allowable number of hops. In various alternative embodiments, the NMS may monitor all peers for various network topology changes regardless of whether an alarm is explicitly set by the user. Upon detecting a change in network topology that triggers an alarm, the NMS may display an alarm indication on the associated sync topology. In various embodiments, the NMS may be further configured to suppress alarms for various reasons or to correlate alarms to relevant portions of the underlying routing topology or to causes of the change to the underlying topology.

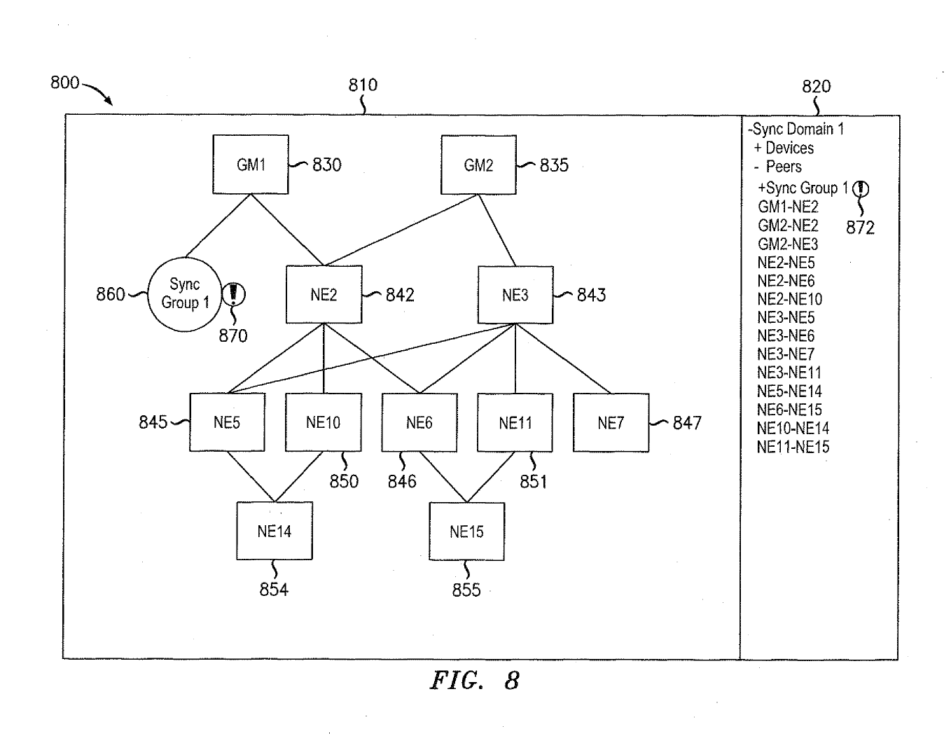

FIG. 8 illustrates an exemplary GUI 800 representing an exemplary synchronization domain including a synchronization group and an alarm indication. As shown, GUI 800 may be similar to GUI 200, including a map 810 and a list 820. Map 810 may include GM devices 830, 835, network elements 842, 843, 845-847, 850, 851, 854, 855, and Sync Group 1 860.

GUI 800 may also include alarm indications 870, 872 indicating that a change to network topology has triggered one or more alarms. As shown, alarm indications 870, 872 may include an image of an exclamation point. It will be understood that any alarm indication may be used. For example, the alarm indication may include a different image, displaying sync group 1 860 in a different color or shading, flashing sync group 1 860, underlining or bolding the sync group 1 list item, or playing a sound clip.

Alarm indications 870, 872 may correspond to the network changes represented by network topology 700. As such, alarms may be triggered for the peers exiting between GM1 730 and NE1 741 or NE9 749 and NE14 754. GUI 800 may display the alarm indications 870, 872 in association with sync group 1 860 and the sync group 1 list item, respectively, because the impacted peers may belong to Sync Group 1. As described above, the user may be able to “drill down” into the Sync Group by selecting Sync Group 1 860 or the Sync Group 1 list item.

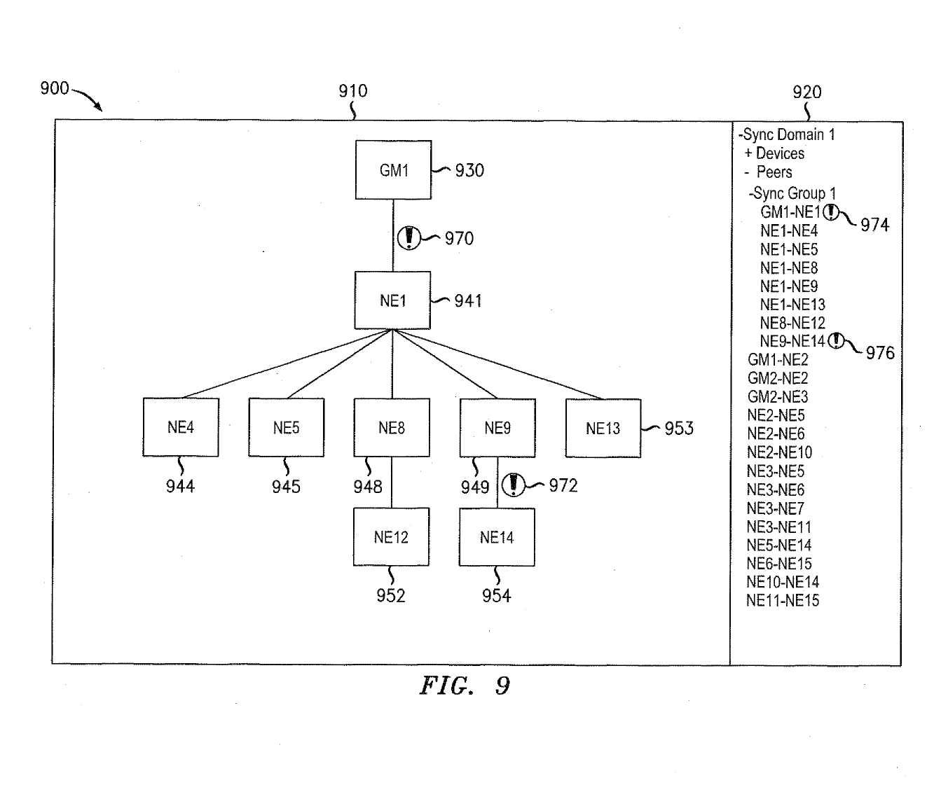

FIG. 9 illustrates an exemplary GUI 900 representing an exemplary synchronization group and an alarm indication. GUI 900 may be displayed as a result of the user “drilling down” into Sync Group 1 from GUI 800. GUI may be similar to GUI 300, including a map 910 and a list 920. Map 910 may include GM1 930, and network elements 941, 944, 945, 948, 949, 952-954.

GUI 900 may include a number of alarm indications 970, 972, 974, 976. Alarm indications 970, 974 may be displayed in association with the peer between GM1 930 and NE1 941. As such, alarm indications 970, 974 may be displayed in response to the rerouting of that peer according to route 780 of FIG. 7. As another example, alarm indications 972, 976 may be displayed in association with the peer between NE9 949 and NE14 954. As such, alarm indications 972, 976 may be displayed in response to the rerouting of that peer according to route 784 of FIG. 7.

In various embodiments, GUI 800 or 900 may enable a user to select an alarm indication to display additional information related to the alarm. For example, upon receiving a selection of one of alarm indications 870, 872, 970, 972, 974, 976, the NMS may display route topology 700. By viewing route topology 700, a user may be able to identify the network change(s) that triggered the alarm. The NMS may also provide historical analysis with respect to the network topology upon receiving a request for a historical analysis view. For example, the NMS may receive an instruction from the user to display a network topology at some previous time. Alternatively, the instruction may specify a previous configuration or simply request historical analysis without specifying any point in time. In response, the NMS may display a network topology as it existed at the specified time. For example, the NMS may display route topology 600, thereby enabling the user to determine how the network topology has changed with respect to a previous state. It will be apparent that these historical analysis functions may also be provided with respect to the sync topology.

Returning to FIG. 4, NMS 400 may include components capable of providing the described alarm functionality.

Network topology generator 440 may include hardware or executable instructions on a machine-readable storage medium configured to generate a representation of a network topology. For example, network topology generator 440 may generate a GUI including network topology 600 or 700 and display such GUI to a user via user interface 405. Network topology generator 440 may generate such a GUI based on the contents of network route storage 445.

Network route storage 445 may be a device that stores information related to various devices and routes making up a network topology. For example, network route storage 445 may store a list of network devices and routes currently being used between such network devices. Such information may also include a cross reference to one or more peers stored in sync peer storage 415. Further, network route storage 445 may store similar information associated with previous states of the network topology for use in historical analysis. Thus, network route storage 445 may include a machine-readable storage medium such as read-only memory (ROM), random-access memory (RAM), magnetic disk storage media, optical storage media, flash-memory devices, and/or similar storage media. In various embodiments, network route storage 445 may include at least some hardware in common with sync peer storage 415 or sync group storage 435. For example, network route storage 445 and sync peer storage 415 may be separate data structures of a single storage device.

Route analyzer 450 may include hardware or executable instructions on a machine-readable storage medium configured to periodically poll various network devices to determine the routes currently being traveled between such network devices. In various embodiments, route analyzer 450 may include an Alcatel-Lucent 5650 Control Plane Assurance Manager (CPAM). Upon polling a device or probe located in the network, route analyzer 450 may determine the routes being traveled and store such information, along with a time stamp, in network route storage. In various alternative embodiments, route analyzer may receive route messages pushed by various devices without first polling the devices.

Alarm creator 455 may include hardware or executable instructions on a machine-readable storage medium configured to receive, via user interface 405, definitions of alarms to be evaluated by NMS 400. For example, alarm creator 455 may receive a selection of a peer to be monitored. Alarm creator 455 may also request and receive one or more alarm trigger criteria for determining when an alarm has been triggered. For example, a user may specify that the alarm will be triggered if the total number of hops exceeds a specified threshold or if the propagation delay along the peer's route increases by a specified proportion. Various alternative trigger criteria will be apparent. After receiving this information, alarm creator 455 may store a definition of the new alarm in alarm storage 460.

Alarm storage 460 may be a device that stores various alarm definitions. For example, alarm storage 460 may store a list of alarms, their associated peers, and trigger criteria, if any. Thus, alarm storage 460 may include a machine-readable storage medium such as read-only memory (ROM), random-access memory (RAM), magnetic disk storage media, optical storage media, flash-memory devices, and/or similar storage media. In various embodiments, alarm storage 460 may include at least some hardware in common with sync peer storage 415, sync group storage 435, or network route storage 445. For example, alarm storage 460 and sync peer storage 415 may be separate data structures of a single storage device.

Alarm evaluator 465 may include hardware or executable instructions on a machine-readable storage medium configured to determine whether an alarm defined in alarm storage 460 is triggered by routes stored in network storage 445. In various embodiments, such evaluation may be triggered by an indication from route analyzer 450 that new route information has been added to network route storage 445. Upon determining that one or more alarms have been triggered, alarm evaluator may display one or more alarm indications via user interface. For example, alarm evaluator 465 may display alarm indicators 870, 872, 970, 972, 974, or 976. Alarm evaluator 465 may further be configured to receive a selection of an alarm indicator and respond by displaying additional alarm information or by prompting network topology generator to display an appropriate network topology view.

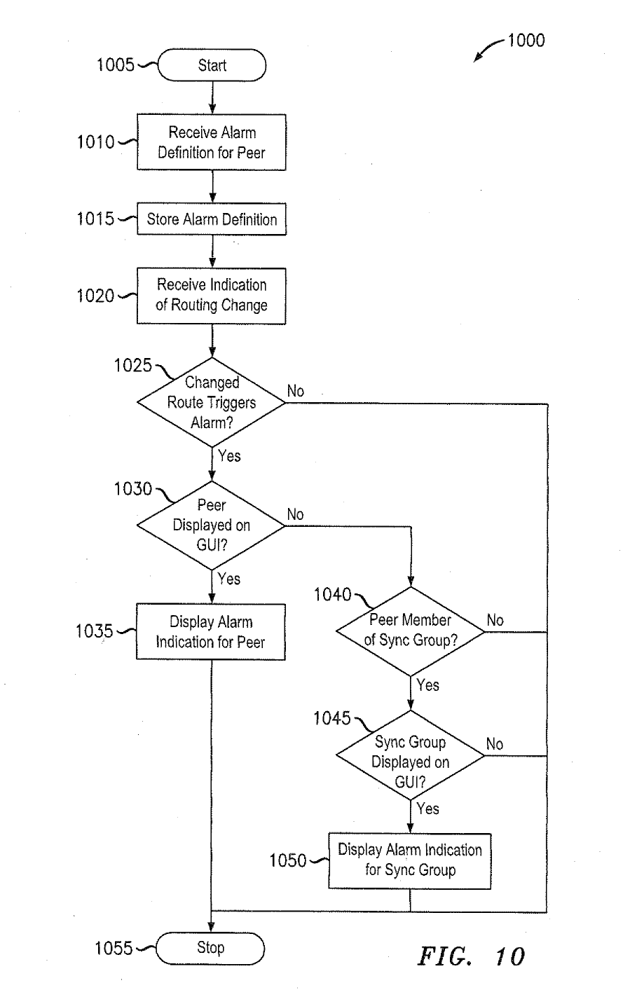

FIG. 10 illustrates an exemplary method 1000 for configuring and evaluating an alarm. Method 1000 may be performed by an NMS such as, for example, NMS 400. In various embodiments, method 1000 may be performed by route analyzer 450, alarm creator 455, or alarm evaluator 465.

Method 1000 may begin in step 1005 and proceed to step 1010 where the NMS may receive a definition of a new alarm for a sync peer. Such alarm definition may be associated with a peer, clock, or network element and may additionally include one or more alarm trigger criteria. Next, in step 1015, the NMS may store the alarm definition for future evaluation.

In step 1020, the NMS may receive an indication that one or more routes have changed. Then, in step 1025, the NMS may determine whether the route change causes any stored alarms to trigger. For example, the NMS may iterate through any stored alarms to determine if the route is associated with any peer for which an alarm is defined. As will be understood, various alternative embodiments may employ method other than iteration to determine whether an alarm is defined for changed route. For example, the routing path may be known as associated with a peer and a fault on the routing path may propagate up to the peer in the sync topology. If the route is associated with an peer for which an alarm is defined, the NMS may go on to evaluate the trigger criteria (if any) associated with the alarm. If the routing change meets the trigger criteria, or if no trigger criteria are defined, method 1000 may proceed to step 1030. Otherwise, method 1000 may proceed directly to end in step 1055.

Next, the NMS may determine, in step 1030, whether the peer associated with the alarm is currently displayed on the GUI. If the peer is currently displayed, the method 1000 may proceed to step 1035, where the NMS may display an alarm indication in association with the displayed peer. For example, an alarm indication may be displayed adjacent to a representation of the peer. Method 1000 may then proceed to end in step 1055.

If, instead, the NMS determines in step 1030 that the peer associated with the alarm is not currently displayed on the GUI, method 1000 may proceed to step 1040. In step 1040, the NMS may determine whether the associated peer is a member of any Sync Groups. If the peer is not a member of any Sync Group, method 1000 may proceed to end in step 1055. Otherwise, the NMS may determine, in step 1045, whether the associated Sync Group is currently displayed on the GUI. If the Sync Group is not displayed on the GUI, method 1000 may proceed to end in step 1055. If, on the other hand, the Sync Group is currently displayed on the GUI, method 1000 may proceed to step 1050 where the NMS may display an alarm indication in association with the displayed Sync Group. For example, an alarm indication may be displayed adjacent to a representation of the sync group. Method 1000 may then proceed to end in step 1055.

Various modifications will be apparent. For example, in the case where neither the peer nor any associated sync group is currently displayed, the NMS may still alert the user of the triggered alarm. In various embodiments, this may include changing the GUI to show a view including the peer or Sync Group or displaying an indication of the alarm in a designated area of the GUI, unassociated with any displayed element.

According to the foregoing, various embodiments facilitate the organized display and management of a sync topology. For example, by grouping various synchronization peers into a synchronization group, the number of elements to be displayed may be reduced. Further, by associating peers with routes through a network topology, an NMS may provide alarm functionality and historical analysis with respect to a synchronization topology.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a network management system for displaying a synchronization topology, the method comprising:
displaying, by the network management system, a first representation of a synchronization topology, wherein the synchronization topology includes a set of network elements and a set of peers;
receiving a selection of at least one selected network element of the set of network elements;
identifying at least one identified peer of the set of peers associated with the at least one selected network element;
adding the at least one identified peer of the set of peers to a first synchronization group; and
displaying a second representation of the synchronization topology, wherein the second representation includes a representation of the first synchronization group.

2. The method of claim 1, wherein the first synchronization group further includes the at least one selected network element.

3. The method of claim 1, wherein the second representation includes a representation of a number of peers less than the number of peers belonging to the set of peers.

4. The method of claim 1, further comprising:
receiving a selection of the first synchronization group; and
displaying a third representation of the first synchronization group, wherein the third representation includes a representation of at least one peer belonging to the synchronization group.

5. The method of claim 4, wherein the third representation of the first synchronization group includes a representation of a second synchronization group.

6. The method of claim 1, further comprising:
discovering a new peer, wherein the new peer is associated with the at least one selected network element; and
adding the new peer to the first synchronization group.

7. The method of claim 1, wherein,
the synchronization topology is associated with a synchronization domain, and
the step of identifying at least one identified peer of the set of peers comprises ensuring that the at least one identified peer belongs to the synchronization domain.

8. The method of claim 1, wherein the second representation includes at least one of a map and a list.

9. A network management system for displaying a synchronization (sync) topology, the network management system comprising:
a user interface;
a sync peer storage configured to store information related to peers;
a sync group storage configured to store information related to groupings of peers;
a sync group creator configured to:
receive, via the user interface, a selection associated with at least two peers for which the sync peer storage stores information, and
update the sync group storage to include information related to a grouping of the at least two peers; and
a sync topology generator configured to:
generate a first representation of the sync topology, wherein the first representation represents the grouping of the at least two peers as a unit, and
display the first representation via the user interface.

10. The network management system of 9, wherein the first representation includes a number of peers less than the number of peers for which the sync peer storage stores information.

11. The network management system of 9, wherein the sync topology generator is further configured to:
receive, via the user interface a selection of the grouping of the at least two peers;
generate a second representation of the sync topology, wherein the second representation represents the at least two peers as separate from each other; and
display the second representation via the user interface.

12. The network management system of 11, wherein the second representation further represents, as a unit, an additional grouping for which information is stored in the sync group storage.

13. The network management system of 9, further comprising:
a network interface; and
a peer discovery module configured to:
discover a new peer via the network interface, wherein a network element associated with the at least two peers is also associated with the new peer,
update the sync peer storage to store information related to the new peer,
wherein the sync group creator is further configured to update the sync group storage to include information related to a grouping of the at least two peers and the new peer.

14. The network management system of 9, wherein the first representation includes at least one of a map and a list.

15. A non-transitory machine-readable storage medium encoded with instructions for execution by a network management system for displaying a synchronization topology, the medium comprising:
instructions for displaying, by the network management system, a first representation of a synchronization topology, wherein the synchronization topology includes a set of network elements and a set of peers;
instructions for receiving a selection of at least one selected network element of the set of network elements;
instructions for identifying at least one identified peer of the set of peers associated with the at least one selected network element;
instructions for adding the at least one identified peer of the set of peers to a first synchronization group; and
instructions for displaying a second representation of the synchronization topology, wherein the second representation includes a representation of the first synchronization group.

16. The non-transitory machine-readable storage medium of claim 15, wherein the second representation includes a representation of a number of peers less than the number of peers belonging to the set of peers.

17. The non-transitory machine-readable storage medium of claim 15, further comprising:
instructions for receiving a selection of the first synchronization group; and
instructions for displaying a third representation of the first synchronization group, wherein the third representation includes a representation of at least one peer belonging to the synchronization group.

18. The non-transitory machine-readable storage medium of claim 17, wherein the third representation of the first synchronization group includes a representation of a second synchronization group.

19. The non-transitory machine-readable storage medium of claim 15, further comprising:
instructions for discovering a new peer, wherein the new peer is associated with the at least one selected network element; and
instructions for adding the new peer to the first synchronization group.

20. The non-transitory machine-readable storage medium of claim 15, wherein,
the synchronization topology is associated with a synchronization domain, and
the instructions for identifying at least one identified peer of the set of peers comprise instructions for ensuring that the at least one identified peer belongs to the synchronization domain.
